(19) United States
(12) Patent Application Publication
(10) Pub. No.: US 2018/0013480 A1
(43) Pub. Date: Jan. 11, 2018

(54) HEADER ENCODING AND MODULATION FOR SINGLE CARRIER PHYSICAL LAYER

(71) Applicant: Intel Corporation, Santa Clara, CA (US)

(72) Inventors: Artyom Lomayev, Nizhny Novgorod (RU); Iaroslav P. Gagiev, Nizhny Novgorod (RU); Alexander Maltsev, Nizhny Novgorod (RU); Michael Genossar, Modiin (IL); Carlos Cordeiro, Portland, OR (US)

(21) Appl. No.: 15/395,178

(22) Filed: Dec. 30, 2016

Related U.S. Application Data
(60) Provisional application No. 62/360,772, filed on Jul. 11, 2016.

(51) Int. Cl. H04B 7/06; H04L 29/08

(52) U.S. Cl. CPC H04B 7/0639; H04L 69/323

(57) ABSTRACT

This disclosure describes systems, methods, and devices related to header encoding and modulation. A device may determine an enhanced directional multi-gigabit (EDMG) header field vector comprising one or more bits. The device may determine a first vector associated with a scrambler device, wherein the first vector includes one or more first random bits. The device may scramble the EDMG header field vector based on the first vector. The device may cause to wirelessly transmit to a first device, a codeword associated with the scrambled EDMG header field vector.

### CROSS-REFERENCE TO RELATED APPLICATION

This application claims the benefit of U.S. Provisional Application No. 62/360,772 filed Jul. 11, 2016, the disclosure of which is incorporated herein by reference as if set forth in full.

### TECHNICAL FIELD

This disclosure generally relates to systems and methods for wireless communications and, more particularly, to header encoding and modulation.

### BACKGROUND

Wireless devices are becoming widely prevalent and are increasingly requesting access to wireless channels. The growing density of wireless deployments requires increased network and spectrum availability. Wireless devices may communicate with each other using directional transmission techniques including, but not limited to, beamforming techniques. Wireless devices may communicate over a next generation 60 GHz (NG60) network, an enhanced directional multi-gigabit (EDMG) network, and/or any other network.

### BRIEF DESCRIPTION OF THE DRAWINGS

FIG. 1 depicts a network diagram illustrating an example network environment for header encoding and modulation, in accordance with one or more example embodiments of the present disclosure.

FIG. 2 depicts an illustrative schematic diagram of a preamble of an enhanced directional multi-gigabit (EDMG) physical layer convergence protocol data unit PPDU, in accordance with one or more example embodiments of the present disclosure.

FIG. 3A depicts a flow diagram of an illustrative process for header encoding and modulation, in accordance with one or more example embodiments of the present disclosure.

FIG. 3B depicts a flow diagram of an illustrative process for header encoding and modulation, in accordance with one or more example embodiments of the present disclosure.

FIG. 4 illustrates a functional diagram of an example communication station that may be suitable for use as a user device, in accordance with one or more example embodiments of the present disclosure.

FIG. 5 is a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices for a multiple-input multiple-output (MIMO) preamble frame format. The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Devices may communicate over a next generation 60 GHz (NG60) network, an enhanced directional multi-gigabit (EDMG) network, and/or any other network. Devices operating in EDMG may be referred to herein as EDMG devices. These devices may include user devices, and/or access points (APs) or other devices capable of communicating in accordance with a communication standard including, but not limited to, IEEE 802.11ad and/or IEEE 802.11ay.

A typical EDMG physical layer convergence protocol data unit (PPDU) frame format may be composed of a legacy preamble, a legacy header, an EDMG-Header-A containing SU-MIMO parameters, an EDMG short training field (EDMG-STF), an EDMG channel estimation field (EDMG-CEF), an EDMG-Header-B containing MU-MIMO parameters, a payload data part and optional AGC and beamforming training units appended at the end of the frame.

The legacy preamble, the legacy header and the new EDMG-Header-A may be transmitted using single input single output (SISO) single carrier (SC) PHY modulation. This provides an opportunity for the legacy directional multi-gigabit (DMG) devices receiving the preamble to decode the legacy header and identify (using a signaling bit) that the frame contains the EDMG part not compatible with its implementation. This realizes a backward compatibility requirement. At the same time, EDMG devices receiving the preamble can decode the EDMG-Header-A using SISO SC PHY and extract the required parameters for MIMO frame reception. The transmission of the rest of the EDMG frame is done using MIMO modulation applying channel bonding. Channel bonding is when two adjacent channels within a given frequency band are combined to increase throughput between two or more wireless devices. This may effectively double the amount of available bandwidth.

The EDMG-Header-B conveying MU-MIMO parameters per user device or per station device (STA) basis may be present in the MU PPDU frames. It is transmitted in the MIMO mode with the possible application of channel bonding. The EDMG-Header-B may contain EDMG-MCS user information, PPDU length, and possibly low-density parity-check (LDPC) code type including regular and extended codeword length. An LDPC code is a linear error correcting code, and it is associated with transmitting a message over a noisy transmission channel. The LDPC codes may be used in applications requiring reliable and highly efficient information transfer over bandwidth or return channel-constrained links in the presence of corrupting noise.

In scenarios where a device such as an access point (AP) is simultaneously sending a preamble to the first user device and another preamble to the second user device such that the preambles include one or more of the same fields, interference may occur due to the simultaneous transmission of the one or more same fields. Legacy systems include cyclic shifts in the time domain in order to introduce a time delay between the preambles whenever simultaneous transmissions occur in order to remedy the interference. However, these delays may accumulate to negatively impact the communication system and/or user experience.

Example embodiments of the present disclosure relate to systems, methods, and devices for header encoding and modulation.

Directional multi-gigabit (DMG) communications may involve one or more directional links to communicate at a rate of multiple gigabits per second, for example, at least 1 gigabit per second, 7 gigabits per second, or any other rate. An amendment to a DMG operation in a 60 GHz band, e.g., according to an IEEE 802.11ad standard, may be defined, for example, by an IEEE 802.11ay project.

In some demonstrative embodiments, one or more devices may be configured to communicate over a next generation 60 GHz (NG60) network, an enhanced DMG (EDMG) network, and/or any other network. For example, the one or more devices may be configured to communicate over the NG60 or EDMG networks.

In one embodiment, a header encoding and modulation system may facilitate encoding and modulation of an EDMG-Header-B field for single carrier PHY in order to be transmitted to a receiving device. The header encoding and modulation system may mitigate interference by differentiating between the simultaneous stream transmissions using the code domain.

In one embodiment, the header encoding and modulation system may be compatible with a legacy header encoding and modulation in accordance with legacy communication standards, such as the IEEE 802.11ad standard. This may result in a reuse of the hardware already implemented in accordance with legacy standards, such as the IEEE 802.11ad standard.

In one embodiment, the header encoding and modulation system may facilitate data scrambling and data encoding of one or more bits associated with the EDMG-Header-B field before transmitting the EDMG-Header-B field to the receiving device using single carrier modulation.

In one embodiment, the header encoding and modulation system may determine one or more initial scrambler seed values to be used when generating a scrambler vector to be used for encoding the EDMG-Header-B field. In some embodiments, the one or more initial scrambler seed values may be based on one or more bits of the EDMG-Header-B field.

In one embodiment, the header encoding and modulation system may facilitate assigning initial scrambler seed values to different user devices such that each user device may have its own initial scrambler seed values. Having initial scrambler seed values on a per user device basis may mitigate the interference that may be caused when a device simultaneously transmits to two or more user devices. A scrambler device may be considered as a random generator that may be initialized with initial seed values in order to produce a random sequence. If the initial seed values are different for each user device, each scrambler associated with each user device may produce random bit sequences that may be differentiated in the time domain.

In one embodiment, the header encoding and modulation system may determine that the EDMG-Header-B is composed of one or more bits (e.g., 64 bits) and may assign a first number of the EDMG-Header-B bits (e.g., the first seven bits: b1, b2, . . . , b7) to initialize a scrambler device and a second number of the EDMG-Header-B bits (e.g., the remainder bits: b8, . . . , b64) that may convey information including, at least in part, a modulation and coding scheme (MCS) or any other identifying information.

In one embodiment, the header encoding and modulation system may determine that a first portion of a scrambler vector associated with a scrambler device is initialized to zeros in order not to scramble the initial seed values. Each vector s may be defined per stream per user device. This may assist a receiving device in determining the initial seed values since they are not scrambled. If the first portion of the scrambler vector is not initialized to zero, it may scramble the first portion of the output of the scrambler device such that the receiving device may be unable to determine the initial seed values. Consequently, the receiving device would not be able to reconstruct the scrambler vector in order to apply reverse operations when decoding the receive sequences.

In one embodiment, the header encoding and modulation system may utilize the scrambler vector and the EDMG-Header-B bits in order to generate a codeword representing a scrambled EDMG-Header-B (e.g., bs=b×s; where x defines bitwise exclusive OR (XOR) of two vectors). It should be understood that the XOR operation is an exclusive OR operation that gives a true (1/HIGH) output when the number of true inputs is odd. That is, a true output results if one, and only one, of the inputs to the gate is true. If both inputs are false (0/LOW) or both are true, a false output results. XOR represents the inequality function, that is, the output is true if the inputs are not alike, and otherwise the output is false.

In one embodiment, the header encoding and modulation system may utilize π/2-BPSK modulation for single carrier modulation when modulating the codeword in preparation for transmission to the receiving device.

The above descriptions are for purposes of illustration and are not meant to be limiting. Numerous other examples, configurations, processes, etc., may exist, some of which are described in greater detail below. Example embodiments will now be described with reference to the accompanying figures.

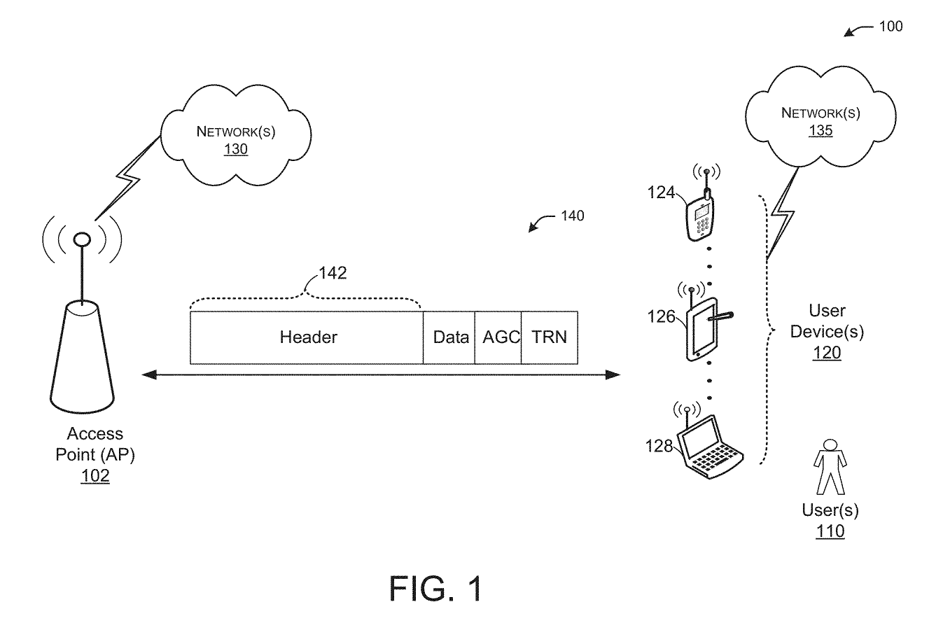

FIG. 1 is a network diagram illustrating an example network environment for header encoding and modulation, in accordance with one or more example embodiments of the present disclosure. Wireless network 100 may include one or more user device(s) 120 and one or more access point(s) (AP) 102, which may communicate in accordance with IEEE 802.11 communication standards, such as the IEEE 802.11ad and/or the IEEE 802.11ay specifications. The user device(s) 120 may be referred to as stations (STAs). The user device(s) 120 may be mobile devices that are non-stationary and do not have fixed locations. Although the AP 102 is shown to be communicating on multiple antennas with the user devices 120, it should be understood that this is only for illustrative purposes and that any user device 120 may also communicate using multiple antennas with other user devices 120 and/or the AP 102.

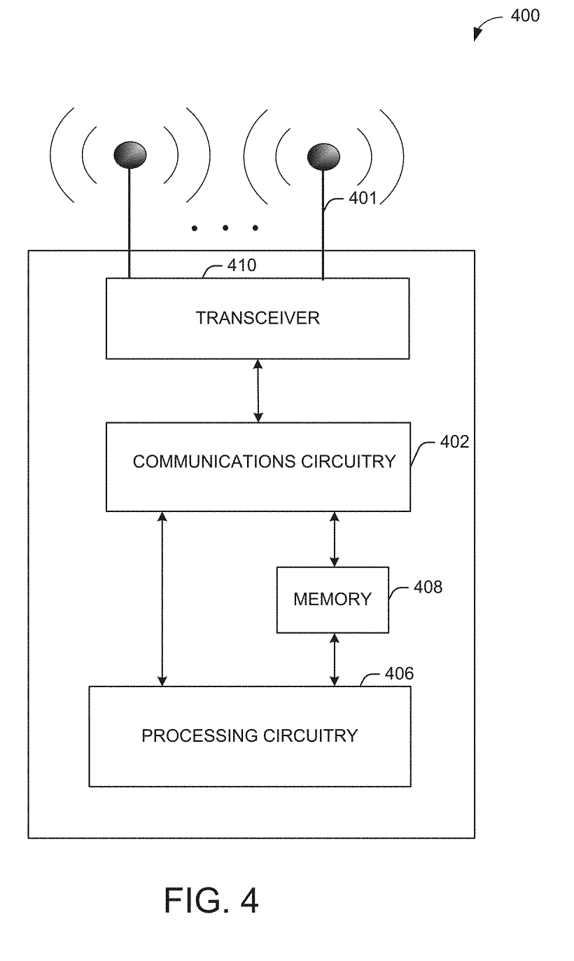

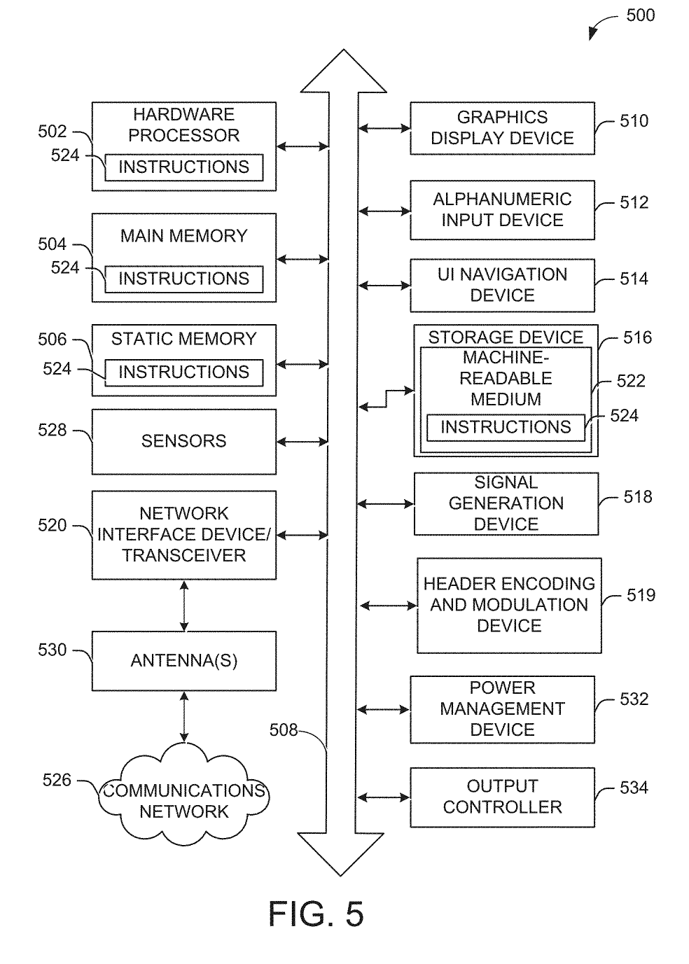

In some embodiments, the user devices 120 and AP 102 may include one or more computer systems similar to that of the functional diagram of FIG. 4 and/or the example machine/system of FIG. 5.

One or more illustrative user device(s) 120 and/or AP 102 may be operable by one or more user(s) 110. The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. It is understood that the above is a list of devices. However, other devices, including smart devices such as lamps, climate control, car components, household components, appliances, etc. may also be included in this list.

Any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennas. The one or more communications antennas may be any suitable type of antennas corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124, 126, 128), and AP 102 may be configured to perform directional transmission and/or directional reception in conjunction with wirelessly communicating in a wireless network. Any of the user device(s) 120 (e.g., user devices 124, 126, 128), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP 102 may be configured to perform any given directional transmission towards one or more defined transmit sectors. Any of the user device(s) 120 (e.g., user devices 124, 126, 128), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Some demonstrative embodiments may be used in conjunction with a wireless communication network communicating over a frequency band of 60 GHz. However, other embodiments may be implemented utilizing any other suitable wireless communication frequency bands, for example, an extremely high frequency (EHF) band (the millimeter wave (mmWave) frequency band), a frequency band within the frequency band of between 20 GHz and 300 GHz, a WLAN frequency band, a WPAN frequency band, a frequency band according to the WGA specification, and the like.

The phrases “directional multi-gigabit (DMG)” and “directional band (DBand)”, as used herein, may relate to a frequency band wherein the channel starting frequency is above 45 GHz. In one example, DMG communications may involve one or more directional links to communicate at a rate of multiple gigabits per second, for example, at least 1 gigabit per second, 7 gigabits per second, or any other rate.

In some demonstrative embodiments, the user device(s) 120 and/or the AP 102 may be configured to operate in accordance with one or more specifications, including one or more IEEE 802.11 specifications, (e.g., an IEEE 802.11ad specification, an IEEE 802.11ay specification, and/or any other specification and/or protocol). For example, an amendment to a DMG operation in the 60 GHz band, according to an IEEE 802.11ad standard, may be defined, for example, by an IEEE 802.11ay project.

In one embodiment, and with reference to FIG. 1, there is shown a general frame format for the EDMG PPDU 140 for single carrier PHY. Besides the preamble 142, the EDMG PPDU 140 may include a data part and optional AGC and beamforming training units (TRNs). It is understood that the above acronyms may be different and are not to be construed as a limitation because other acronyms may be used for the fields included in an EDMG PPDU 140.

In one embodiment, a header in an encoding and modulation system may prepare the EDMG PPDU 140 for transmission from a transmitting device (e.g., the user devices 120 and/or the AP 102) to a receiving device (e.g., the user device 120 and/or the AP 102). When signals are being prepared for transmission using single carrier PHY from the transmitting device to the receiving device, one or more steps may be taken. The steps may include data scrambling using the scrambler device, data encoding using the encoding device, and modulation using the modulation device. When signals are received by the receiving device, one or more steps may be taken. The steps may include demodulation of the receive signals using the demodulation device, decoding of the receive signals using the decoding device, and descrambling the signals using the descrambler device.

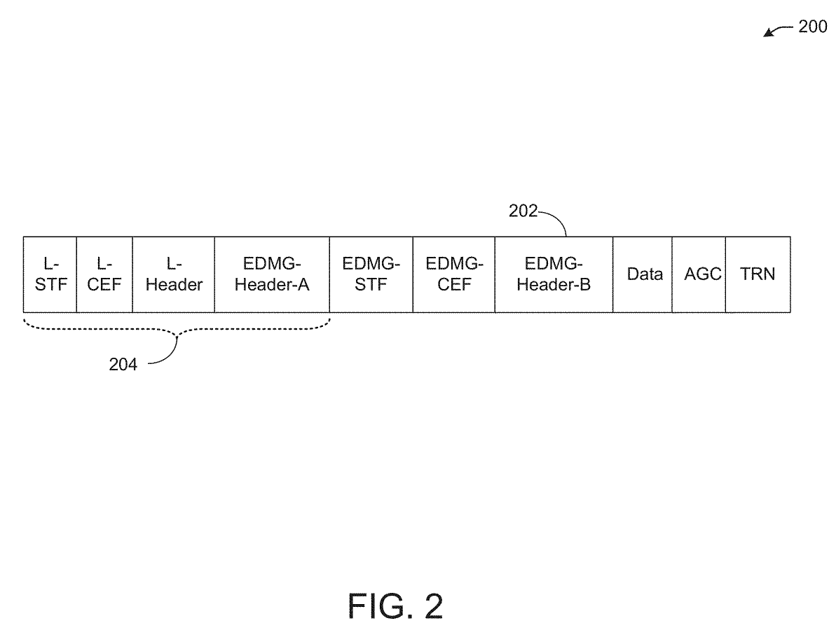

FIG. 2 depicts an illustrative schematic diagram of a preamble of an EDMG PPDU, in accordance with one or more example embodiments of the present disclosure.

Referring to FIG. 2, there is shown a preamble 200 of an EDMG PPDU 140 (of FIG. 1). The preamble 200 may include, at least in part, a legacy short training field (L-STF), a legacy channel estimation field (L-CEF), a legacy header (L-Header), an EDMG-Header-A, an EDMG-STF, an EDMG-CEF, and an EDMG-Header-B 202.

In one embodiment, fields 204 may include at least the L-STF, the L-CEF, L-Header, and the EDMG-Header-A. The fields 204 may be transmitted using single input single output (SISO) SC PHY modulation. The rest of the preamble 200 may be transmitted using SISO or MIMO modulation with the possible application of channel bonding.

In one embodiment, a header encoding and modulation system may encode and modulate at least in part the EDMG-Header-B 202 for single carrier PHY. For example, during downlink (DL) MU-MIMO transmission, an AP may assign different seed values to be used in a scrambler device to different user devices. Hence, each user device would have its own scrambler initial seed value, bⁱ=(b1, b2, . . . , b7)ⁱ depending on the space-time stream index “i.” The total number of space-time streams may be defined by N_{STS}, so the index i=1:N_{STS}. If each user device has a single stream, then the initial seed value selection by the AP may guarantee that each user device will have its own unique codeword vector associated with the EDMG-Header-B 202, csⁱ, that may be transmitted to a receiving device. The receiving device may then perform reverse operations such as the scrambling, decoding, etc., in order to recover the EDMG-Header-B 202.

In one embodiment, the encoding of the EDMG-Header-B 202 for single stream per user device may be defined as follows. The EDMG-Header-B 202 may be composed of 64 bits b=(b₁, b₂, . . . , b₆₄). Those bits may be used as input during an encoding process during the header encoding and modulation of the EDMG-Header-B. The encoding may be divided into two sub-cases. The first sub-case is related to MIMO transmissions to multiple users, where the MIMO transmissions may be using a single stream per user device. The second sub-case is related to a multi-stream per user device.

In the first sub-case, if simultaneous transmissions between, for example, an AP and multiple users are using a single stream per user, some of the content of the header may be the same between these single streams. For example, if different users have the same content of a header field, when the MIMO transmissions occur, where the AP has a single stream with each of the user devices, interference may occur which may lead to unintentional beamforming with an unintended user device.

In one embodiment, in order to avoid the unintentional beamforming in the first sub-case, the header encoding and modulation system may introduce a scrambler seed to differentiate the single streams during the MIMO transmissions. The scrambler seed may be composed of seven bits. The seven bits may be defined differently for each user device.

A transmitting device (e.g., the user device(s) 120 and/or the AP 102 of FIG. 1) may include at least in part a scrambler device, an LDPC encoder, and a modulation device. A receiving device (e.g., the user device(s) 120 and/or the AP 102 of FIG. 1) may include at least in part a demodulation device, a decoder device, and a descrambler device.

When signals are being prepared for transmission using single carrier PHY from a transmitting device to a receiving device, one or more steps may be taken. The steps may include data scrambling using the scrambler device, data encoding using the encoding device, and modulation using the modulation device. When signals are received by the receiving device, one or more steps may be taken. The steps may include demodulation of the receive signals using the demodulation device, decoding of the receive signals using the decoding device, and descrambling the signals using the descrambler device.

In one embodiment, the EDMG-Header-B 202 may be composed of 64 bits, where the first seven bits of the EDMG-Header-B 202 may be designated as initial scrambler seed values to be inputted into the scrambler device. The remaining bits of the EDMG-Header-B 202 may convey parameters such as EDMG MCS values and/or other parameters.

In one embodiment, the header encoding and modulation system may utilize the first seven bits of the EDMG-Header-B 202 to be used during scrambling using the scrambler device. The scrambler device may be considered as a random generator that may be initialized with some initial seed values in order to produce random bit sequences. Having different initial seeds, the data scrambler may output different random bit sequences. Although the first seven bits of the EDMG-Header-B 202 may be used as initial seed values for data scrambling, other numbers of bits from the EDMG-Header-B 202 may be used in order to differentiate between the streams.

During data scrambling, a vector s=(0₁, 0₂, . . . , 0₇, s₁, s₂, s₅₇) is created. The first seven bits of the vector s are set to zeros and the s₁, s₂, . . . , s₅₇ may be the first 57 bits at the output of the scrambler device with an initial seed value (b₁, b₂, . . . b₇) of the EDMG-Header-B 202 is used. The bits of the EDMG-Header-B 202 may then be scrambled by multiplying the vector b with the vector s using a bitwise XOR. That is, bs=b×s; where x defines the bitwise XOR of the two vectors b and s. It should be noted that the first seven bits of the vector s may be set to a value of zero. One reason to set the first seven bits of the vector s to zeros is to not affect the first seven bits when scrambling the EDMG-Header-B 202 bits. In that case, a receiving device that may receive the scrambled EDMG-Header-B 202 may be able to determine the initial seed value used to perform data scrambling at the transmitting device that transmitted the scrambled EDMG-Header-B 202. This way, the receiving device may be able to restore the vector s by knowing the initial seed values used. The receiving device may then utilize the restored vector s and may perform a reverse operation in order to reconstruct the EDMG-Header-B 202.

In one embodiment, the header encoding and modulation system may perform data encoding after performing the data scrambling. During data encoding, an LDPC codeword may be generated by appending 440 zeros to the 64 bits from the scrambled EDMG-Header-B 202 (e.g., the bs bits), which may create the required length to encode using the LDPC ¾ parity check matrix, and by appending 168 parity bits after the 440 zeros. The resulting LDPC codeword, c, may be:

c=(bs₁, bs₂, . . . , bs₆₄, 0₁, 0₂, . . . , 0₄₄₀, p₁, p₂, . . . , p₁₆₈).

Further, a parity check matrix H defined as the 168×672 LDPC ¾ parity check matrix may be used to solve a system of linear equations using Hc^{T}=0, where T indicates a transform of the LDPC codeword c in order to determine whether the codeword c is valid or invalid. Further, two vectors, c1 and c2, may be generated. For example, c1 may be generated by discarding the 440 zeros in the c codeword and by using the first 64 bits from the scrambled EDMG-Header-B 202 bits then appended with 160 bits (e.g., p₁, p₂, . . . , p₁₆₀) of the parity bits. That is, c1=(bs₁, bs₂, . . . , bs₆₄, p₁, p₂, . . . , p₁₆₀). Further, c2 may be generated by discarding the 440 zeros in the c codeword and by using the first 64 bits from the scrambled EDMG-Header-B 202 bits then appended with 160 bits (e.g., p₁, p₂, . . . , p₁₅₂, p₁₆₁, p₁₆₂, . . . , p₁₆₈), such that some parity bits (e.g., p₁₅₃, p₁₅₄, . . . p₁₆₀) are removed. That is, c2=(bs₁, bs₂, . . . , bs₆₄, p₁, p₂, . . . , p₁₅₂, p₁₆₁, p₁₆₂, . . . , p₁₆₈). A resulting codeword may be determined as c=(c1, c2), which may be comprised of 448 bits.

In one embodiment, the header encoding and modulation system may then scramble the resulting codeword c=(c1, c2) before transmitting it to the receiving device. During scrambling of the codeword c, a new vector s may be determined. The new vector s may be defined as s=(0₁, 0₂, . . . , 0₂₂₄, s₁, s₂, . . . , s₂₂₄), where s₁, s₂, . . . , s₂₂₄ are the first 224 bits at the output of the scrambler device with an initial seed value (1₁, 1₂, . . . , 1₇). The first 224 bits of the vector s is set to zeros in order not to affect the first codeword c1 and to keep it unchanged. At the output of the scrambler device, the codeword c may be multiplied by the new vector s using a bitwise XOR in order to generate a cs vector. That is, cs=c×s; where x defines bitwise the XOR of the two vectors c and s. The resulting cs vector may be transmitted to the receiving device using single carrier PHY modulation. It is understood that the above descriptions are for purposes of illustration and are not meant to be limiting.

In one embodiment, the header encoding and modulation system may differentiate between each stream transmission when a user device has more than one stream. For example, an AP may have established two or more streams with one user device. The header encoding and modulation system may encode the EDMG-Header-B 202 for multi-streams per user. In this case, a similar problem may exist such that the interference may result in unintentional beamforming in the case of simultaneous transmission of duplicate information between streams of a user device. The unintentional beamforming issue is the same as the above case of a single stream per user interference. However, the problem is now over the individual streams of the same user device.

Similar to the single stream transmissions described above, data scrambling may be performed to generate scrambled EDMG-Header-B 202 bits using a scrambler vector S having the first seven bits equal to zeros, followed by 57 random bits of output of the scrambler device with the initial seed value equal to the first seven bits of the EDMG-Header-B bits. After the data scrambling, data encoding may include the steps of generating a resulting codeword c=(c1, c2) of 448 bits in length. After generating the resulting codeword, the resulting codeword is then scrambled using an s vector associated with each stream. This may result in a cs^{N} , where N is the number of space-time streams per user device. It should be understood that the above steps are performed on a per stream basis for each user.

In one embodiment, if the AP transmits N space-time streams per user, then it creates N codewords for N streams obtained by the bitwise XOR operation applied to the original codeword as shown in the single stream transmissions above. That is, a cs vector may be generated for each stream as follows:

cs¹=c×s¹, cs²=c×s², . . . cs^{N}=c×s^{N};

where c is the original code vector introduced above in the data encoding step;

s¹=(0₁, 0₂, . . . , 0₂₂₄, s₁, s₂, . . . , s₂₂₄), where s¹ is the scrambler vector for stream #1;

s²=(s₂₂₅, s₂₂₆, . . . , s₆₇₂), where s² is the scrambler vector for stream #2;

. . . ; and

s^{N}=(s_{(N-1)*448-224+1}, s_{(N-1)*448-224+2}, . . . , s_{N*448-224}), where s^{N} is the scrambler vector for stream #N.

The s¹ scrambler vector may be defined as having 448 bits, such that the first 224 bits are set to zeros and the other bits are random bits generated by the scrambler device. The s² scrambler vector may be made up of 448 random bits generated from the scrambler device and continue after the last bit of the s¹ scrambler vector. This may continue until the s^{N} scrambler vector is reached.

It should be noted that all bits: s₁, s₂, . . . , s_{N*448-224} may be obtained from the output of the scrambler device with the initial seed value (1₁, 1₂, . . . , 1₇). It should be noted that this operation may guarantee that space-time streams intended for one user will have different codewords. This may prevent the cases where the signals are detected and as a consequence the effect of unintentional beamforming. It is understood that the above descriptions are for purposes of illustration and are not meant to be limiting.

In one embodiment, the header encoding and modulation system may determine the modulation of the EDMG-Header-B 202 for single carrier transmission. The modulation of the EDMG-Header-B 202 for single carrier transmission may establish that each codeword csⁱ for a space-time stream with index “i” may be modulated using π/2-BPSK modulation. This modulation may provide a single carrier symbol block blkⁱ of length 448 chips for the i-th stream.

Each block blkⁱ may be prepended with guard interval (GI), which may be defined differently. In a particular example, the GI may be defined as a Golay Gaⁱ₆₄ sequence of length 64 chips. The set {Gaⁱ₆₄, i=1:N_{STS}} comprises the set of mutually orthogonal Ga Golay sequences. This may provide a regular single carrier symbol blocking for the i-th space-time stream as follows: [Gaⁱ₆₄, blkⁱ].

In one embodiment, the header encoding and modulation system may establish that the symbol block blkⁱ may be repeated based on the number of bonded channels (e.g., N_{CB}) to support different channel bonding factors as follows:

In case the number of the bonded channel is either N_{CB}=1, 2, 3 or 4, the respective symbol blocking for the i-th space-time stream may be:

N_{CB}=2: [Gaⁱ₁₂₈, blkⁱ, blkⁱ]; where blkⁱ is repeated two times.

N_{CB}=3: [Gaⁱ₁₉₂, blkⁱ, blkⁱ, blkⁱ]; where blkⁱ is repeated three times.

N_{CB}=4: [Gaⁱ₂₅₆, blkⁱ, blkⁱ, blkⁱ, blkⁱ]; where blkⁱ is repeated four times.

The guard interval (GI) length may be scaled in an appropriate number N_{CB} (number of bonded channels) as follows:

N_{GI CB}=64*N_{CB}=128 (for N_{CB}=2), 192 (for N_{CB}=3), and 256 (for N_{CB}=4).

It should be appreciated that the application of any type of interleaver scheme over the group of blocks blkⁱ may be possible.

In another embodiment, a header encoding and modulation system for single carrier transmission may facilitate repeating the single carrier symbol block corresponding to an EDMG-Header-B in time with sign inversion as follows:

N_{CB}=1: [Gaⁱ₆₄, blkⁱ, Gaⁱ₆₄, −blkⁱ,];

N_{CB}=2: [Gaⁱ₁₂₈, blkⁱ, blkⁱ, Gaⁱ₁₂₈, −blkⁱ, −blkⁱ];

N_{CB}=3: [Gaⁱ₁₉₂, blkⁱ, blkⁱ, blkⁱ, Gaⁱ₁₉₂, −blkⁱ, −blkⁱ, −blkⁱ];

N_{CB}=4: [Gaⁱ₂₅₆, blkⁱ, blkⁱ, blkⁱ, blkⁱ, Gaⁱ₂₅₆, −blkⁱ, −blkⁱ, −blkⁱ, −blkⁱ].

It is understood that the above descriptions are for purposes of illustration and are not meant to be limiting.

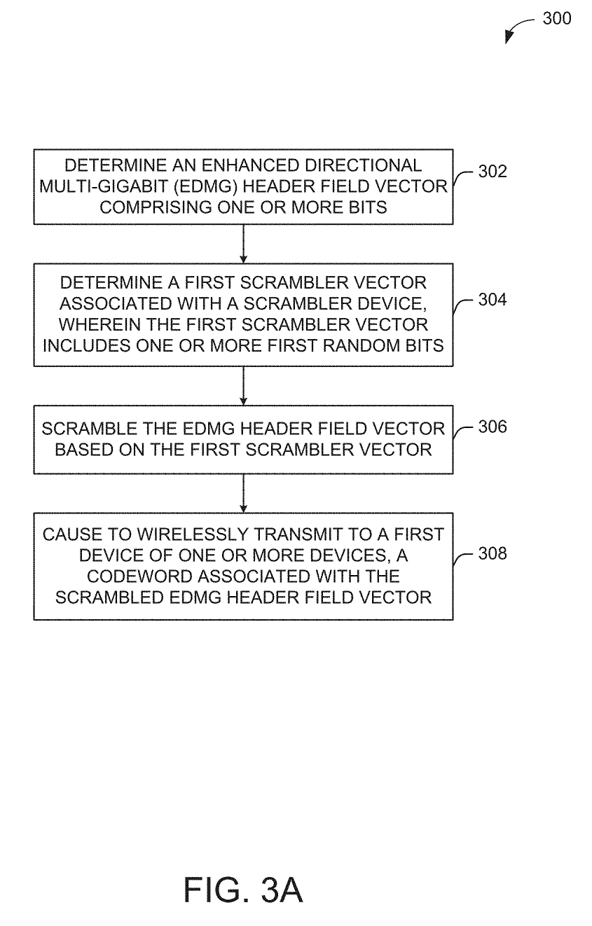

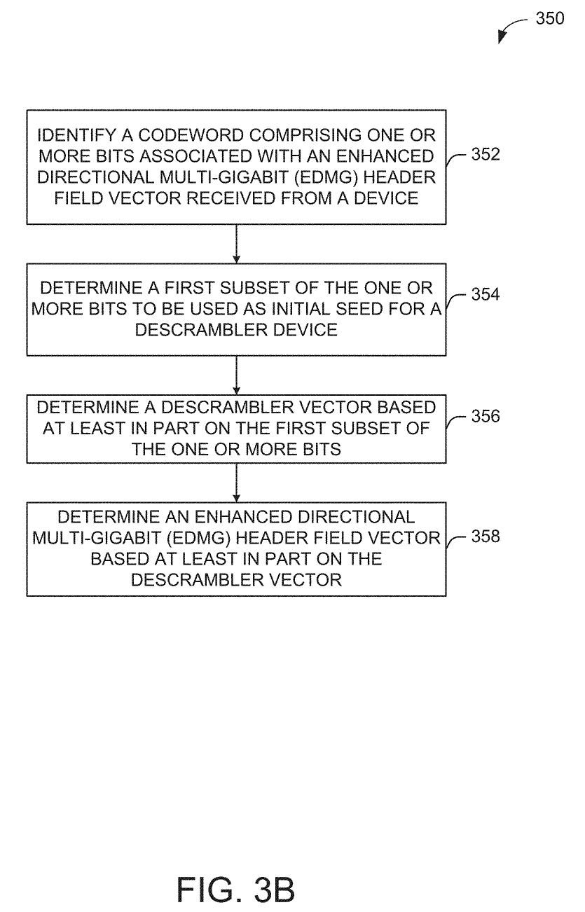

FIG. 3A illustrates a flow diagram of an illustrative process 300 for an illustrative header encoding and modulation system, in accordance with one or more example embodiments of the present disclosure.

At block 302, a transmitting device (e.g., the user device(s) 120 and/or the AP 102 of FIG. 1) may determine an enhanced directional multi-gigabit (EDMG) header field vector comprising one or more bits. For example, an AP 102 may determine a header that includes an EDMG-Header-B field to be transmitted to a user device 120. In order for the AP 102 to transmit the EDMG-Header-B field, the AP 102 may have to encode and modulate this field before transmission. During data scrambling, the AP 102 may utilize the first seven bits of the EDMG-Header-B to be used during data scrambling using a data scrambler device.

At block 304, the transmitting device may determine a first scrambler vector associated with a scrambler device, wherein the first scrambler vector includes one or more first random bits. The scrambler vector may be associated with a scrambler device. The scrambler device may be considered a random bit generator that may be initialized with initial seed values to produce the random bit sequences. If different initial seeds are defined, the scrambler device may output different random bit sequences. For example, a scrambler vector (e.g., vector s=(0₁, 0₂, . . . , 0₇, s₁, s₂, . . . , s₅₇)) may be comprised of 64 bits, such that the first seven bits are set to zeros and the next 57 bits are the first 57 bits at the output of the scrambler device with an initial seed value equal to the first seven bits of the EDMG-Header-B. The first seven bits of the scrambler vector may be set to zeros in order to not affect the first seven bits of the EDMG-Header-B vector after being scrambled with the scrambler vector. In that case, a receiving device receiving the scrambled EDMG-Header-B may be able to determine the initial seed value used to perform data scrambling at the transmitting device. The receiving device may be able to determine the initial seed value by performing reverse operations. This way, the receiving device may be able to restore the scrambler vector by using the initial seed values.

At block 306, the transmitting device may scramble the EDMG header field vector based on the first scrambler vector. For example, the bits of the EDMG-Header-B may be scrambled by multiplying the vector (e.g., vector b) representing the EDMG-Header-B with the scrambler vector (e.g., vector s) using a bitwise XOR operation. This will result in a scrambled EDMG-Header-B. After scrambling the EDMG-Header-B, data encoding may be performed such that a resulting codeword may be generated. During data encoding, an LDPC codeword may be generated by appending 440 zeros to the 64 bits from the scrambled EDMG-Header-B 202 (e.g., the bs bits), which may create the required length to encode using the LDPC ¾ parity check matrix, and by appending 168 parity bits after the 440 zeros. The resulting LDPC codeword, c, may be:

c=(bs₁, bs₂, . . . , bs₆₄, 0₁, 0₂, . . . , 0₄₄₀, p₁, p₂, . . . , p₁₆₈).

Further, a parity check matrix H defined as the 168×672 LDPC ¾ parity check matrix may be used to solve a system of linear equations using Hc^{T}=0, where T indicates a transform of the LDPC codeword c in order to determine whether the codeword c is valid or invalid. Further, two vectors, c1 and c2, may be generated. For example, c1 may be generated by discarding the 440 zeros in the c codeword and by using the first 64 bits from the scrambled EDMG-Header-B 202 bits then appended with 160 bits (e.g., p₁, p₂, . . . , p₁₆₀) of the parity bits. That is, c1=(bs₁, bs₂, . . . , bs₆₄, p₁, p₂, . . . , p₁₆₀). Further, c2 may be generated by discarding the 440 zeros in the c codeword and by using the first 64 bits from the scrambled EDMG-Header-B 202 bits then appended with 160 bits (e.g., p₁, p₂, . . . , p₁₅₂, p₁₆₁, p₁₆₂, . . . , p₁₆₈), such that some parity bits (e.g., p₁₅₃, p₁₅₄, . . . , p₁₆₀) are removed. That is, c2=(bs₁, bs₂, . . . , bs₆₄, p₁, p₂, . . . , p₁₅₂, p₁₆₁, p₁₆₂, . . . , p₁₆₈). A resulting codeword may be determined as c=(c1, c2), which may be comprised of 448 bits.

At block 308, the transmitting device may cause to wirelessly transmit to a first device of one or more devices, a codeword associated with the scrambled EDMG header field vector. For example, an AP may scramble the resulting codeword c=(c1, c2) before transmitting it to the receiving device (e.g., the user device 120 of FIG. 1). During scrambling of the codeword c, a new vector s may be determined. The new vector s may be defined as s=(0₁, 0₂, . . . , 0₂₂₄, s₁, s₂, . . . , s₂₂₄), where s₁, s₂, . . . , s₂₂₄ are the first 224 bits at the output of the scrambler device with the initial seed value (1₁, 1₂, . . . , 1₇). The first 224 bits of the vector s is set to zeros in order not to affect the first codeword c1 and to keep it unchanged. At the output of the scrambler device, the codeword c may be multiplied by the vector s using a bitwise XOR in order to generate a cs vector. That is, cs=c×s; where x defines the bitwise XOR of the two vectors c and s. The resulting cs vector may be transmitted to the receiving device using single carrier PHY modulation (e.g., π/2-BPSK modulation). It is understood that the above descriptions are for purposes of illustration and are not meant to be limiting.

FIG. 3B illustrates a flow diagram of an illustrative process 350 for an illustrative header encoding and modulation system, in accordance with one or more example embodiments of the present disclosure.

At block 352, a receiving device (e.g., the user device(s) 120 and/or the AP 102 of FIG. 1) may identify a codeword comprising one or more bits associated with an enhanced directional multi-gigabit (EDMG) header field vector (e.g., the EDMG-Header-B) received from a transmitting device (e.g., the user device(s) 120 and/or the AP 102 of FIG. 1). For example, a user device 120 may include at least in part a demodulation device, a decoder device, and a descrambler device. When the cs vector is transmitted from the transmitting device (e.g., the AP 102) to the receiving device, the receiving device may receive this cs vector and may pass it, at least in part, through the demodulation device, the decoder device, and the descrambler device. In order for the receiving device to be able to identify the EDMG-Header-B, the receiving device may reconstruct the scrambler vector used at the transmitting device in order to use it when decoding and descrambling the received cs vector.

At block 354, the receiving device may determine a first subset of the one or more bits to be used as initial seed for a descrambler device. The receiving device may determine from the received cs vector the initial seed values to be used for the descrambler device.

At block 356, the receiving device may determine a descrambler vector based at least in part on the first subset of the one or more bits. Since on the transmitting device, the initial scrambler vector (e.g., vector s) was determined to have the first seven bits set to zeros (e.g., vector s=(0₁, 0₂, . . . , 0₇, s₁, s₂, . . . , s₅₇)), the receiving device may be able to determine the seed value comprising the first seven bits of the EDMG-Header-B.

At block 358, the receiving device may determine an enhanced directional multi-gigabit (EDMG) header field vector based at least in part on the descrambler vector. For example, using the reverse operations performed at the transmitting device and using the same initial seed values (e.g., (b₁, b₂, . . . , b₇) of the EDMG-Header-B), the receiving device may be able to determine the EDMG-Header-B.

It is understood that the above descriptions are for purposes of illustration and are not meant to be limiting.

FIG. 4 shows a functional diagram of an exemplary communication station 400 in accordance with some embodiments. In one embodiment, FIG. 4 illustrates a functional block diagram of a communication station that may be suitable for use as an AP 102 (FIG. 1) or a user device 120 (FIG. 1) in accordance with some embodiments. The communication station 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 400 may include communications circuitry 402 and a transceiver 410 for transmitting and receiving signals to and from other communication stations using one or more antennas 401. The communications circuitry 402 may include circuitry that can operate the physical layer (PHY) communications and/or media access control (MAC) communications for controlling access to the wireless medium, and/or any other communications layers for transmitting and receiving signals. The communication station 400 may also include processing circuitry 406 and memory 408 arranged to perform the operations described herein. In some embodiments, the communications circuitry 402 and the processing circuitry 406 may be configured to perform operations detailed in FIGS. 1, 2, 3A and 3B.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the communication station 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device , read-only memory (ROM), random-access memory (RAM), magnetic disk storage media, optical storage media, flash-memory devices and other storage devices and media.

In some embodiments, the communication station 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 400 may include one or more of a keyboard, a display, a non-volatile memory port, multiple antennas, a graphics processor, an application processor, speakers, and other mobile device elements. The display may be an LCD screen including a touch screen.

Although the communication station 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device memory.

FIG. 5 illustrates a block diagram of an example of a machine 500 or system upon which any one or more of the techniques (e.g., methodologies) discussed herein may be performed. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a speaker), a header encoding and modulation device 519, a network interface device/transceiver 620 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

The header encoding and modulation device 519 may carry out or perform any of the operations and processes (e.g., the processes 300 and 350) described and shown above. For example, the header encoding and modulation device 519 may facilitate encoding and modulation of an EDMG-Header-B field for single carrier PHY in order to be transmitted to a receiving device. The header encoding and modulation device 519 may mitigate interference by differentiating between the simultaneous stream transmissions using the code domain.

The header encoding and modulation device 519 may be compatible with a legacy header encoding and modulation in accordance with legacy communication standards, such as the IEEE 802.11ad standard. This may result in a reuse of the hardware already implemented in accordance with legacy standards, such as the IEEE 802.11ad standard.

The header encoding and modulation device 519 may facilitate data scrambling and data encoding of one or more bits associated with the EDMG-Header-B field before transmitting the EDMG-Header-B field to the receiving device using single carrier modulation.

The header encoding and modulation device 519 may determine one or more initial scrambler seed values to be used when generating a scrambler vector to be used for encoding the EDMG-Header-B field. In some embodiments, the one or more initial scrambler seed values may be based on one or more bits of the EDMG-Header-B field.

The header encoding and modulation device 519 may facilitate assigning initial scrambler seed values to different user devices such that each user device may have its own initial scrambler seed values. Having initial scrambler seed values on a per user device basis may mitigate the interference that may be caused when a device simultaneously transmits to two or more user devices. A scrambler device may be considered as a random generator that may be initialized with initial seed values in order to produce a random sequence. If the initial seed values are different for each user device, each scrambler device associated with each user device may produce random bit sequences that may be differentiated in the time domain.

The header encoding and modulation device 519 may determine that the EDMG-Header-B is composed of one or more bits (e.g., 64 bits) and may assign a first number of the EDMG-Header-B bits (e.g., the first seven bits: b1, b2, . . . , b7) to initialize a scrambler device and a second number of the EDMG-Header-B bits (e.g., the remainder bits: b8, . . . , b64) that may convey information including, at least in part, a modulation and coding scheme (MCS) or any other identifying information.

The header encoding and modulation device 519 may determine that a first portion of a scrambler vector associated with a scrambler device is initialized to zeros in order not to scramble the initial seed values. Each vector s may be defined per stream per user device. This may assist a receiving device in determining the initial seed values since they are not scrambled. If the first portion of the scrambler vector is not initialized to zero, it may scramble the first portion of the output of the scrambler device such that the receiving device may be unable to determine the initial seed values. Consequently, the receiving device would not be able to reconstruct the scrambler vector in order to apply reverse operations when decoding the receive sequences.

The header encoding and modulation device 519 may utilize the scrambler vector and the EDMG-Header-B bits in order to generate a codeword representing a scrambled EDMG-Header-B (e.g., bs=b×s; where x defines the bitwise exclusive OR (XOR) of two vectors). It should be understood that the XOR operation is an exclusive OR operation that gives a true (1/HIGH) output when the number of true inputs is odd. That is, a true output results if one, and only one, of the inputs to the gate is true. If both inputs are false (0/LOW) or both are true, a false output results. XOR represents the inequality function, that is, the output is true if the inputs are not alike, and otherwise the output is false.

The header encoding and modulation device 519 may utilize π/2-BPSK modulation for single carrier modulation when modulating the codeword in preparation for transmission to the receiving device.

It is understood that the above are only a subset of what the header encoding and modulation device 519 may be configured to perform and that other functions included throughout this disclosure may also be performed by the header encoding and modulation device 519.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include memory and processing circuitry configured to determine an enhanced directional multi-gigabit (EDMG) header field vector may include one or more bits. The memory and processing circuitry may be further configured to determine a first vector associated with a scrambler device, wherein the first vector may include one or more first random bits. The memory and processing circuitry may be further configured to cause to modify the EDMG header field vector based on the first vector. The memory and processing circuitry may be further configured to cause to wirelessly transmit to a first device, a codeword associated with the modified EDMG header field vector.

The implementations may include one or more of the following features. The first vector is based at least in part on using a subset of the one or more bits of the EDMG header field vector as initial seed values for the scrambler device. The subset of the one or more bits of the EDMG header field vector comprises seven bits. The EDMG header field vector is associated with a space-time stream between the device and the first device. Causing to modify the EDMG header field vector may include performing a bitwise XOR operation between the first vector and the EDMG header field vector. The codeword is determined based on performing a bitwise XOR operation between a second vector and an original codeword. The original codeword may include a first codeword and a second codeword, wherein the first codeword is comprised of the modified EDMG header field vector and one or more first parity bits, and the second codeword is comprised of the modified EDMG field vector and one or more second parity bits. The memory and the processing circuitry may further be configured to modulate the codeword associated with the modified EDMG header field vector. The memory and the processing circuitry may be further configured to determine a first space-time stream between the device and a second device of the one or more devices. The memory and processing circuitry may be further configured to determine a second space-time stream between the device and the second device. The memory and processing circuitry may be further configured to determine a first vector associated with the first space-time stream. The memory and processing circuitry may be further configured to determine a second vector associated with the second space-time stream. The memory and processing circuitry may be further configured to determine a first codeword based on performing a bitwise XOR operation between the first vector and a codeword. The memory and processing circuitry may be further configured to determine a second scrambled codeword based on performing a bitwise XOR operation between the second vector and the codeword. The memory and the processing circuitry are further configured to cause to wirelessly transmit the first codeword to the second device using the first space-time stream. The memory and processing circuitry may be further configured to cause to wirelessly transmit the second scrambled codeword to the second device using the second space-time stream. The device may further include a transceiver configured to transmit and receive wireless signals. The device may further include one or more antennas coupled to the transceiver.

According to example embodiments of the disclosure, there may be a device. The device may include memory and processing circuitry configured to identify a codeword may include one or more bits associated with an enhanced directional multi-gigabit (EDMG) header field vector received from a device. The memory and processing circuitry may be further configured to determine a first subset of the one or more bits to be used as initial seed values for a descrambler device. The memory and processing circuitry may be further configured to determine a descrambler vector based at least in part on the first subset of the one or more bits. The memory and processing circuitry may be further configured to determine an EDMG header field vector based at least in part on the descrambler vector. The implementations may include one or more of the following features. The EDMG header field vector comprises 64 bits. The codeword is modulated using a single carrier modulation. The single carrier modulation is based on a binary phase shift keying modulation. A first portion of the descrambler vector is set to one or more zero bits.

According to example embodiments of the disclosure, there may be a non-transitory computer-readable medium storing computer-executable instructions which, when executed by a processor, cause the processor to perform operations. The operations may include identifying a codeword may include one or more bits associated with an enhanced directional multi-gigabit (EDMG) header field vector received from a device. The operations may include determining a first subset of the one or more bits to be used as initial seed values for a descrambler device. The operations may include determining a descrambler vector based at least in part on the first subset of the one or more bits. The operations may include determining an EDMG header field vector based at least in part on the descrambler vector.

The implementations may include one or more of the following features. The EDMG header field vector comprises 64 bits. The codeword is modulated using a single carrier modulation. The single carrier modulation is based on a binary phase shift keying modulation. A first portion of the descrambler vector is set to one or more zero bits.

According to example embodiments of the disclosure, there may be a non-transitory computer-readable medium storing computer-executable instructions which, when executed by a processor, cause the processor to perform operations. The operations may include determining, by one or more processors, an enhanced directional multi-gigabit (EDMG) header field vector may include one or more bits. The operations may include determining a first vector associated with a scrambler device, wherein the first vector may include one or more first random bits. The operations may include scrambling the EDMG header field vector based on the first vector. The operations may include causing to wirelessly transmit to a device, a codeword associated with the scrambled EDMG header field vector.

The implementations may include one or more of the following features. The first vector is based on using a subset of the one or more bits of the EDMG header field vector as initial seed values for the scrambler device. Scrambling the EDMG header field vector may include performing a bitwise XOR operation between the first vector and the EDMG header field vector. The subset of the one or more bits of the EDMG header field vector comprises seven bits. The EDMG header field vector is associated with a space-time stream between the device and the first device. The codeword is determined based on performing a bitwise XOR operation between a second vector and an original codeword. The original codeword may include a first codeword and a second codeword, wherein the first codeword is comprised of the modified EDMG header field vector and one or more first parity bits, and the second codeword is comprised of the modified EDMG field vector and one or more second parity bits. The operations may further comprise modulating the codeword associated with the modified EDMG header field vector. The operations may include determining a first space-time stream between the device and a second device of the one or more devices. The operations may include determining a second space-time stream between the device and the second device. The operations may include determining a first vector associated with the first space-time stream. The operations may include determining a second vector associated with the second space-time stream. The operations may include determining a first codeword based on performing a bitwise XOR operation between the first vector and a codeword. The operations may include determining a second scrambled codeword based on performing a bitwise XOR operation between the second vector and the codeword. The operations may further comprise causing to wirelessly transmit the first codeword to the second device using the first space-time stream. The operations may include causing to wirelessly transmit the second scrambled codeword to the second device using the second space-time stream.

According to example embodiments of the disclosure, there may include a method. The method may include determining, by one or more processors, an enhanced directional multi-gigabit (EDMG) header field vector may include one or more bits. The method may include determining a first vector associated with a scrambler device, wherein the first vector includes one or more first random bits. The method may include scrambling the EDMG header field vector based on the first vector. The method may include causing to wirelessly transmit to a device, a codeword associated with the scrambled EDMG header field vector.

The implementations may include one or more of the following features. The first vector is based on using a subset of the one or more bits of the EDMG header field vector as initial seed values for the scrambler device. The EDMG header field vector includes performing a bitwise XOR operation between the first vector and the EDMG header field vector. The subset of the one or more bits of the EDMG header field vector comprises seven bits. The EDMG header field vector is associated with a space-time stream between the device and the first device. The codeword is determined based on performing a bitwise XOR operation between a second vector and an original codeword. The original codeword includes a first codeword and a second codeword, wherein the first codeword is comprised of the modified EDMG header field vector and one or more first parity bits, and the second codeword is comprised of the modified EDMG field vector and one or more second parity bits. The method may further comprise modulating the codeword associated with the modified EDMG header field vector. The method may further include determining a first space-time stream between the device and a second device of the one or more devices. The method may include determining a second space-time stream between the device and the second device. The method may include determining a first vector associated with the first space-time stream. The method may include determining a second vector associated with the second space-time stream. The method may include determining a first codeword based on performing a bitwise XOR operation between the first vector and a codeword. The method may include determining a second scrambled codeword based on performing a bitwise XOR operation between the second vector and the codeword. The method may further include causing to wirelessly transmit the first codeword to the second device using the first space-time stream. The method may include causing to wirelessly transmit the second scrambled codeword to the second device using the second space-time stream.

According to example embodiments of the disclosure, there may include a method. The method may include identifying a codeword may include one or more bits associated with an enhanced directional multi-gigabit (EDMG) header field vector received from a device. The method may include determining a first subset of the one or more bits to be used as initial seed values for a descrambler device. The method may include determining a descrambler vector based at least in part on the first subset of the one or more bits. The method may include determining an EDMG header field vector based at least in part on the descrambler vector.

The implementations may include one or more of the following features. The EDMG header field vector comprises 64 bits. The codeword is modulated using a single carrier modulation. The single carrier modulation is based on a binary phase shift keying modulation. A first portion of the descrambler vector is set to one or more zero bits.

In example embodiments of the disclosure, there may be an apparatus. The apparatus may include means for determining, by one or more processors, an enhanced directional multi-gigabit (EDMG) header field vector may include one or more bits. The apparatus may include means for determining a first vector associated with a scrambler device, wherein the first vector includes one or more first random bits. The apparatus may include means for scrambling the EDMG header field vector based on the first vector. The apparatus may include means for causing to wirelessly transmit to a device, a codeword associated with the scrambled EDMG header field vector.

The implementations may include one or more of the following features. The first vector is based on using a subset of the one or more bits of the EDMG header field vector as initial seed values for the scrambler device. The means for scrambling the EDMG header field vector may include performing a bitwise XOR operation between the first vector and the EDMG header field vector. The subset of the one or more bits of the EDMG header field vector comprises seven bits. The EDMG header field vector is associated with a space-time stream between the device and the first device. The codeword is determined based on performing a bitwise XOR operation between a second vector and an original codeword. The original codeword includes a first codeword and a second codeword, wherein the first codeword is comprised of the modified EDMG header field vector and one or more first parity bits, and the second codeword is comprised of the modified EDMG field vector and one or more second parity bits. The apparatus may further include means for modulating the codeword associated with the modified EDMG header field vector. The apparatus may further include means for determining a first space-time stream between the device and a second device of the one or more devices. The apparatus may further include means for determining a second space-time stream between the device and the second device. The apparatus may further include means for determining a first vector associated with the first space-time stream. The apparatus may further include means for determining a second vector associated with the second space-time stream. The apparatus may further include means for determining a first codeword based on performing a bitwise XOR operation between the first vector and a codeword. The apparatus may further include means for determining a second scrambled codeword based on performing a bitwise XOR operation between the second vector and the codeword. The apparatus may further include means for causing to wirelessly transmit the first codeword to the second device using the first space-time stream. The apparatus may further include means for causing to wirelessly transmit the second scrambled codeword to the second device using the second space-time stream.

In example embodiments of the disclosure, there may be an apparatus. The apparatus may include means for identifying a codeword may include one or more bits associated with an enhanced directional multi-gigabit (EDMG) header field vector received from a device. The apparatus may include means for determining a first subset of the one or more bits to be used as initial seed values for a descrambler device. The apparatus may include means for determining a descrambler vector based at least in part on the first subset of the one or more bits. The apparatus may include means for determining an EDMG header field vector based at least in part on the descrambler vector.

The implementations may include one or more of the following features. The EDMG header field vector comprises 64 bits. The codeword is modulated using a single carrier modulation. The single carrier modulation is based on a binary phase shift keying modulation. A first portion of the descrambler vector is set to one or more zero bits.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising memory and processing circuitry configured to:
determine an enhanced directional multi-gigabit (EDMG) header field vector comprising one or more bits;
determine a first vector associated with a scrambler device, wherein the first vector includes one or more first random bits;
cause to modify the EDMG header field vector based on the first vector; and
cause to wirelessly transmit to a first device, a codeword associated with the modified EDMG header field vector.

2. The device of claim 1, wherein the first vector is based at least in part on using a subset of the one or more bits of the EDMG header field vector as initial seed values for the scrambler device.

3. The device of claim 2, wherein the subset of the one or more bits of the EDMG header field vector comprises seven bits.

4. The device of claim 1, wherein the EDMG header field vector is associated with a space-time stream between the device and the first device.

5. The device of claim 1, wherein causing to modify the EDMG header field vector includes performing a bitwise XOR operation between the first vector and the EDMG header field vector.

6. The device of claim 1, wherein the codeword is determined based on performing a bitwise XOR operation between a second vector and an original codeword.

7. The device of claim 6, wherein the original codeword includes a first codeword and a second codeword, wherein the first codeword is comprised of the modified EDMG header field vector and one or more first parity bits, and the second codeword is comprised of the modified EDMG field vector and one or more second parity bits.

8. The device of claim 1, wherein the memory and the processing circuitry are further configured to modulate the codeword associated with the modified EDMG header field vector.

9. The device of claim 1, wherein the memory and the processing circuitry are further configured to:
determine a first space-time stream between the device and a second device of the one or more devices;
determine a second space-time stream between the device and the second device;
determine a first vector associated with the first space-time stream;
determine a second vector associated with the second space-time stream;
determine a first codeword based on performing a bitwise XOR operation between the first vector and a codeword; and
determine a second scrambled codeword based on performing a bitwise XOR operation between the second vector and the codeword.

10. The device of claim 9, wherein the memory and the processing circuitry are further configured to:
cause to wirelessly transmit the first codeword to the second device using the first space-time stream; and
cause to wirelessly transmit the second scrambled codeword to the second device using the second space-time stream.

11. The device of claim 1, further comprising a transceiver configured to transmit and receive wireless signals.

12. The device of claim 11, further comprising one or more antennas coupled to the transceiver.

13. A non-transitory computer-readable medium storing computer-executable instructions which when executed by one or more processors result in performing operations comprising:
identifying a codeword comprising one or more bits associated with an enhanced directional multi-gigabit (EDMG) header field vector received from a device;
determining a first subset of the one or more bits to be used as initial seed values for a descrambler device;
determining a descrambler vector based at least in part on the first subset of the one or more bits; and
determining an EDMG header field vector based at least in part on the descrambler vector.

14. The non-transitory computer-readable medium of claim 13, wherein the EDMG header field vector comprises 64 bits.

15. The non-transitory computer-readable medium of claim 13, wherein the codeword is modulated using a single carrier modulation.

16. The non-transitory computer-readable medium of claim 15, wherein the single carrier modulation is based on a binary phase shift keying modulation.

17. The non-transitory computer-readable medium of claim 13, wherein a first portion of the descrambler vector is set to one or more zero bits.

18. A method comprising:
determining, by one or more processors, an enhanced directional multi-gigabit (EDMG) header field vector comprising one or more bits;
determining a first vector associated with a scrambler device, wherein the first vector includes one or more first random bits;
scrambling the EDMG header field vector based on the first vector; and
causing to wirelessly transmit to a device, a codeword associated with the scrambled EDMG header field vector.

19. The method of claim 18, wherein the first vector is based on using a subset of the one or more bits of the EDMG header field vector as initial seed values for the scrambler device.

20. The method of claim 18, wherein scrambling the EDMG header field vector includes performing a bitwise XOR operation between the first vector and the EDMG header field vector.
